(19) United States
(12) Patent Application Publication
(10) Pub. No.: US 2023/0130817 A1
(43) Pub. Date: Apr. 27, 2023

(54) THE FIBER BRAGG GRATING INTELLIGENT DEVICE AND METHOD FOR MONITORING COAL LEVEL IN BUNKER

(71) Applicant: Henan Polytechnic University, Jiaozuo City (CN)

(72) Inventors: Shiming Wei, Jiaozuo City (CN); Zesheng Zhang, Jiaozuo City (CN)

(21) Appl. No.: 17/049,247

(22) PCT Filed: May 15, 2020
(86) PCT No.: PCT/CN2020/090605

§ 371 Date: Oct. 20, 2020

(30) Foreign Application Priority Data
Dec. 26, 2019 (CN) 201911370439.2

(51) Int. Cl. G01F 23/18; G01D 5/353

(52) U.S. Cl. CPC G01F 23/18; G01D 5/35316; G08B 21/18

(57) ABSTRACT

The invention declares a FBG (fiber Bragg grating) intelligent device and method for monitoring coal level in bunker. The device comprises a support device located above the bunker and detachably connected with a vibration device. The vibration device, with a surrounding reserved groove on its shell, extends into the bunker, and the groove is used for embedding FBG sensing device which is connected with FBG Network Demodulator. The Demodulator is electrically connected with a data processing system which is electrically connected with an alarm device, and the alarm device is connected with the belt conveyer. The invention relates to wavelength drifts of FGB, which has fast response and high precision, and can transmit signals to the display device first, providing good operating environment for the bunker.

### FIELD OF THE INVENTION

The invention relates to the technical field of coalmine equipment, especially to the FBG intelligent device and method for monitoring the coal level in bunker.

### BACKGROUND OF THE INVENTION

With development of intelligent producing in coalmines, coal bunker has become an important connecting between surface and underground. When the raw coal flows into the bunker, there are often large amounts of coal dust and bulky rock blocks accompanied. When the coal level in the bunker is too high, coal overflowing will occur, which will directly lead to the conveyer belt damage and casualties. When rock blocks or coal lumps fall in a relatively high humidity environment, coal blockage will possibly occur, and if it is not detected in time, the bunker will be blocked at its bottom. During the course of coal unloading at the bottom of the bunker, if there is no methods to let the coal level under the specified limit, the gate of the bunker may be damaged, or coal dust may float everywhere in the air which may bring unsafe factors to production. In order to realize continuous process of coal mining, it is necessary to adopt accurate monitoring of coal level in bunker. Present monitoring technologies for coal level in bunker are mainly divided into two types, contact and non-contact methods. Contact methods include heavy hammer, electrode, capacitance, machine rod, weighing and rotary wing wheel type. Non-contact methods include radar, ultrasonic, laser and nuclear type, etc. Among them, methods based on radar, ultrasonic and laser technology are commonly used in coalmines. The working principle of radar testing device for coal level is that it transmits electromagnetic wave signals to the coal surface through the transmitting probe, and receives the reflected wave signals by the receiving probe. Since the transmitting time of radar waves is proportional to the distance to coal surface, the distance can be obtained through data processing of computer. The working principle of ultrasonic testing device for coal level is that it emits ultrasonic waves using a transmitting probe with fixed frequency, and the waves will be reflected to the receiving probe after reaching the coal surface. According to the time interval from transmitting to receiving and the spreading speed of the wave in the air, the distance from surface to roof of coal can be obtained through data processing of computer. The working principle of laser testing device for coal level is that it emits a laser beam through an emitting device, and the receiving device is placed at the other end. If the coal level in the bunker exceeds the position of the devices, the laser beam will be interrupted, and the receiving end will not have signals. After amplification and comparison processing by computer, the real-time coal level in the bunker can be determined. The environment of bunker underground is very complicated, and the above-mentioned devices also have many deficiencies.

(1) For the radar testing device of coal level, when the radar wave is sent to coal surface, it will be reflected in disorderly directions due to the rough surface, and some coal will absorb the wave. All these will greatly affect the accuracy of the device. The bunker underground is often in harsh environment with coal dust and various radioactive substance, which may accumulate on the end surface of the transmitter after a period of time. It will seriously affect the transmission and reception of radar waves and make the device ineffective.

(2) For the ultrasonic testing device of coal level, it emits ultrasonic waves from the transmitting probe which may be reflected off the wall of the bunker, thus the receiving probe cannot receive the wave signal. When the reflected wave reaches the other side of the wall, the secondary reflection will occur, and if it is received by the receiving probe, false signals may be generated which affects the monitor accuracy. In addition, the use of the device is closely related to the ratio of diameter to depth of the bunker. When the ratio is not at the monitoring range of the device, the result will not be accurate. The device also requires that the shape of the bunker must be regular and its inner wall be smooth, which will greatly limit its application underground.

(3) For the laser testing device of coal level, it will also be affected by the harsh conditions of bunker underground. Under humidity conditions, coal dust will gather at the reflecting and receiving end of the device, which will greatly reduce the measurement accuracy of the meter. Generally, the depth of bunker is more than 40 m, and coal will mostly crash the bunker wall with large impact force in the falling process. If the device installed on the bunker wall is crashed, it will be directly damaged or its service life will be greatly reduced, and the maintenance is quite difficult.

### SUMMARY OF THE INVENTION

The invention aims to provide FBG intelligent device and method for monitoring coal level in bunker, which will not be easily affected by severe environment underground. It can timely monitor and discover the exact coal level, and decide whether the coal blockage appears, which will thus benefit the promotion of intelligent coalmine production.

In order to realize the above purpose, the invention provides the following scheme: a FBG intelligent device and method for monitoring coal level in bunker. The device is located above the coal bunker (23) and comprises a supporting and a vibrating device. The supporting device is located above the coal bunker and detachably connected with the vibration device. The vibration device extends into the coal bunker and a surrounding reserved groove is processed on its shell for FBG sensing device installed which is connected with the Network Demodulator. The Demodulator is electrically connected with a data processing system which is electrically connected with an alarm device. The alarm device is also connected with the conveyer belt.

Preferably, the described supporting device comprises of supporting steel frames symmetrically arranged at the left and right ends of the bunker, the transverse supporting steel beam is laid on the described supporting steel frames which is transversely placed on the supporting steel frames with the steel bar connectors.

Preferably, the described vibration device comprises of the adjustable-speed motor, the vibration connecting rod and the vibration generator. The described vibration connecting rod is connected with the described speed regulating motor by a shaft. The described adjustable-speed motor is detachably connected with the supporting steel beam, and the described vibration generator is threaded connecting with the described vibration connecting rod.

Preferably, the FBG sensing device comprises of FBG wrapped by the protective layer. The described FBG is connected with the FBG Network Demodulator.

Preferably, the FBG sensing device also comprises optical fiber and FBG sensor. The described FBGs are connected in series in the optical fiber. One end of the optical fiber is connected with the FBG sensor, and the other end is connected with the FBG Network Demodulator.

Preferably, the tail-end of the described optical fiber is equipped with the fiber pigtail.

Preferably, the described alarm device comprises the audible and visual alarm and the conveyor emergency brake valve. The described audible and visual alarm is connected with the described data processing system. One end of the described conveyor emergency brake valve is connected with the data processing system, and the other end is connected with the conveyer belt.

Preferably, the described audible and visual alarm will automatically send out alarm sound and flash light beam when the coal level reaches the upper or lower limit to remind the personnel underground to check the coal bunker in time and eliminate the potential danger. The described conveyor emergency brake valve shall stop conveyer belt when the audible and visual alarm device is triggered.

Preferably, the described vibration device also comprises the vibration buffer plate arranged between the supporting steel beam and the adjustable-speed motor. The described vibration buffer plate is in threaded connection with the supporting steel beam.

The FBG intelligent method for monitoring coal level in bunker includes the following steps:

The FBG sensor transmits the stress signal to the static FBG Network Demodulator to converts optical signal into electrical signal through the analysis processing and transmits the electrical signal to the data processing system. After the electrical signal is inputted through analog software, the specific coal level shall be shown on the displayer for the staff to supervise and take corresponding measures;

If the coal level in the bunker exceeds or falls below the limit, the audible and visual alarm, the emergency brake valve and the vibration device shall be triggered;

If coal blockage appears in the coal bunker, the displayer will show the specific height of blockage area; the data processing system shall trigger the audible and visual alarm and the emergency brake valve. The audible and visual alarm shall send out sound signals and light signals to remind the monitoring personnel to check the situation in time, and the emergency brake valve shall stop the coal the conveyer belt in time.

The invention discloses the following technical effects:

(1) High precision and good timeliness. The invention relates to wavelength drifts of FBG reflected light, which has fast response and high precision. It can transmit signals to the displayer first and provide a good environment for operation of coal bunker.

(2) It will not be interfered with by the harsh environment of the coal bunker. It is so difficult to eliminate interference for existing technologies, such as high concentration and humidity of coal dust in coal bunker. The device in this invention will not easily be affected by the harsh environment underground and can stably monitor the coal level in real-time.

(3) Coal blockage can be timely monitored and dredged by this invention. Due to direct contact with coal blocks in the coal bunker, when coal blockage occurs, the stress signal will be transmitted to the data processing system of computer in time. After the signal transmitted to the vibration device, the vibration generator will be triggered in time to dredge the coal bunker.

(4) Easy deployment and maintenance, low cost. FBG has low cost and is a mature technology. It is more convenient than other non-contact coal level meters when deploying. Its service life can reach more than 5 years.

### BRIEF DESCRIPTION OF THE DRAWINGS

To further clearly explain the embodiment of the invention and the technical scheme in the existing technology, the following will briefly introduce the drawings needed in the embodiment. The drawings in the following description are only some embodiments of the present invention. For those common technicians in this filed, other drawings can be obtained according to these drawings without any other creative labor.

FIG. 1 Schematic structural diagram of the invention;

FIG. 2 Partial structural schematic diagram of the vibration device in the invention;

FIG. 3 Partial structural schematic diagram of the FBG sensor device in the invention;

FIG. 4 Partial structural schematic diagram of the optical fiber in the invention;

FIG. 5 The relationship diagram between coal level in bunker and the FBG sensor when the coal level is in a safe range;

FIG. 6 The relationship diagram between coal level in bunker and the FBG sensor when the coal level exceeds the set upper limit;

FIG. 7 The relationship diagram between coal level in bunker and the FBG sensor when the coal level is lower than the lower limit;

FIG. 8 The relationship diagram between the bunker coal level and the FBG sensor when coal blockage occurs in the coal bunker;

Among them, 1 represents supporting steel frame, and 2 supporting steel beam, 3 adjustable-speed motor, 4 vibration buffer plate, 5 vibration connecting rod, 6 vibration generator, 7 reserved groove, 8 FBG, 9 protective layer, 10 optical fiber outlet, 11 optical fiber pigtail, 12 optical fiber, 13 FBG Network Demodulator, 14 FBG temperature sensor, 15 audible and visual alarm, 16 conveyor emergency brake valve, 17 thread, 18 steel bar connector, 19 coal unloading port, 20 monitor, 21 data processing system, 22 coal bunker inlet, 23 coal bunker, 24 conveyer belt and 25 bolt.

### DETAILED DESCRIPTION OF THE INVENTION

The technical scheme in the embodiments of the invention will be described clearly and completely in combination with the drawings in the embodiment of the invention. The described embodiments are only part of in the invention. All other embodiment based on the ones of the invention obtained by those common technicians in this filed without any other creative labor belongs to the scope of protection of the invention.

To make the above objects, features, and advantages of the present invention more clearer and easier to understand, the invention will be described in the details below with reference drawings and detailed description of the presently preferred embodiments.

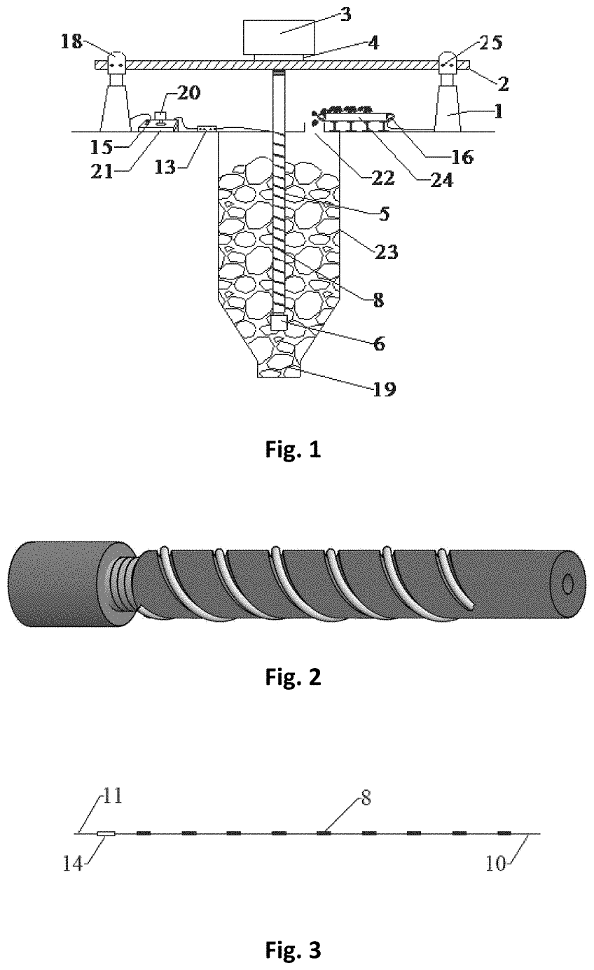

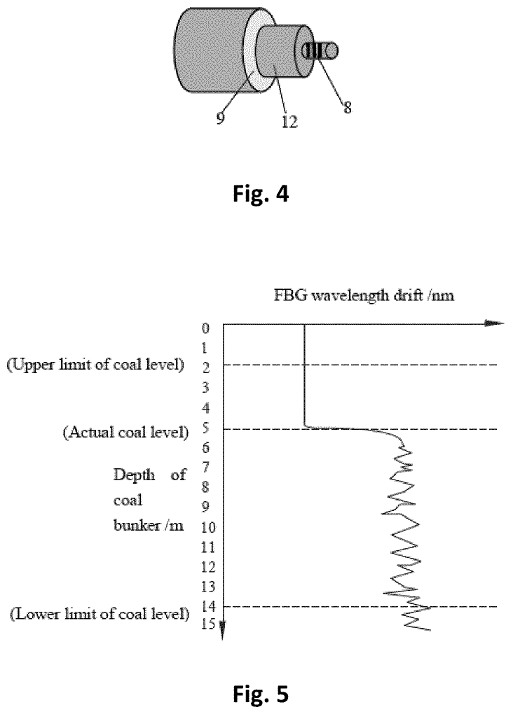

Referring to FIG. 1-8, the embodiment provides a FBG intelligent device for monitoring coal level in coal bunker, which comprises the supporting device. The supporting device is located above the coal bunker 23 and is detachably connected with the vibration device. The vibration device extends into the coal bunker 23 and a surrounding reserved groove 7 is processed on the shell. The reserved groove 7 is used for embedding the FBG sensing device which is connected with the FBG Network Demodulator 13. The FBG Network Demodulator 13 is electrically connected with the data processing system 21, and the data processing system 21 is electrically connected with an alarm device. The alarm device is also connected with the conveyer belt 24. The FBG Network Demodulator 13 is intrinsically safe for coalmine 13. When the FBG senses the strain signal, it will analyze and transmit the signal to the data processing system 21 in time.

By further optimizing the scheme, the described supporting device comprises of supporting steel frames 1 (common supporting steel frame in coalmine) symmetrically arranged at the left and right ends of the coal bunker 23, the transverse supporting steel beam 2 laid on the above-mentioned supporting steel frames 1. The supporting steel beam 2 is transversely placed on the supporting steel frames 1 with the steel bar connectors 18 for stable support.

By further optimizing the scheme, the described vibration device comprises of the described vibration connecting rod 5, the adjustable-speed motor 3, and the vibration generator 6. The described vibration connecting rod 5 is connected with speed regulating motor 3 by a shaft; the described adjustable-speed motor 3 is detachably connected with the supporting steel beam 2, and the described vibration generator 6 is in threaded connection with the vibration connecting rod 5. The vibration connecting rod 5 has the reserved groove 7 and the FBG 8 is stuck in the reserved groove 7 only to leave the optical fiber outlet 10. A layer of thermoplastic rubber is covered in the reserved groove 7 to fill the gaps between the fiber and groove wall. The described adjustable-speed motor 3 consists of the circuit control system and the safe electric engine. The thickness and transverse section of the supporting steel beam 2 must meet the installation requirements of the adjustable-speed motor 3, and its strength should be more than the weight and additional stress of the adjustable-speed motor 3.

By further optimizing the scheme, the described vibration device also comprises the vibration buffer plate 4 which is arranged between the supporting steel beam 2 and the adjustable-speed motor 3. The selected adjustable-speed motor for coal mining is installed on the supporting steel beam 2 through screws. The vibration buffer plate 4 is connected on the supporting steel beam 2 through bolts 25 after punching holes.

The thread 17 is made at the tail end of the reserved groove 7 to connect the vibration generator 6, the vibration generator 6 is fixed with the thread 17, and the thread is made matching with the vibration buffer plate 4 on the top of the vibration connecting rod 5.

By further optimizing the scheme, the FBG sensor comprises the FBG 8 which is connected in series in the optical fiber 12 and marked with numbers according to the depth of the coal bunker. The described FBG 8 is wrapped with the protective layer 9 and spirally arranged on the vibration connecting rod 5 to eliminate error signals caused by temperature. The FBG 8 is connected to the FBG Network Demodulator 13.

By further optimizing the scheme, the FBG sensor device comprises the optical fiber 12 and the FBG sensor 14. The FBG 8 is connected in series in optical fiber 12 and marked with numbers according to the depth of the coal bunker 23. The FBG 8 is wrapped with protective layer 9 and spirally arranged on the vibration connecting rod 5 to eliminate error signals caused by temperature. The FBG Network Demodulator 13 is connected with an optical fiber 12 and a computer, which is placed in a suitable position easily operated by workers. The described FBG Network Demodulator 13 is intrinsic safe for coalmines.

By further optimizing the scheme, the tail end of the optical fiber 12 is provided with an optical fiber pigtail 11 for connecting the FBG Network Demodulator 13.

By further optimizing the scheme, the described alarm device comprises the audible and visual alarm 15 and the conveyor emergency brake valve 16. The audible and visual alarm 15 is connected with the data processing system 21. One end of the conveyor emergency brake valve 16 is connected with the data processing system 21, and the other end is connected with the conveyer belt 24, so that the signal source is stable and the braking is sensitive. The audible and visual alarm 15 is used for automatically emitting alarm sounds and flashing light beams when the coal level reaches the upper or lower limit, reminding the personnel underground to check the coal bunker 23 in time and eliminate potential dangers. The conveyor emergency brake valve 16 is used to stop the conveyer belt 24 when the audible and visual alarm device is triggered.

The described audible and visual alarm 15 is used for automatically emitting alarm sounds and flashing light beams when the coal level reaches the upper or lower limit, reminding the personnel underground to check the coal bunker 23 in time and eliminate potential dangers. The conveyor emergency brake valve 16 is used to stop the operation of the conveyer belt 24 when the audible and visual alarm device is triggered. The conveyor can be manually restored after the potential danger is removed.

The described audible and visual alarm 15 comprises the sound generator and the light source generator, which are all connected to the computer by the single-chip control system. The signal source is stable and can respond quickly. One end of the emergency brake valve 16 is connected to the data processing system 21, and the other end is connected to the main working shaft of the conveyer belt 24, so that the signal source is stable and can brake sensitively.

The working principle of this invention is as follows: the support structure is installed above the coal bunker 23, the monitoring depth is calibrated before installation, and the number of FBGs are marked in the coal bunker with different depths. The vibration device attached to the FBG sensor device is vertically placed in the center position of the coal bunker 23. To prevent the interference from temperature, the FBG temperature sensor 14 is used for temperature compensation to make sure the data monitored is accurate. After the coal falls into the coal bunker 23 from the inlet 22, the shear stress in the steel structure will be generated due to extrusion, and the stress will be transmitted to the FBG sensor 14. This signal will be sent to the FBG Network Demodulator 13 and the coal level of coal bunker 23 can be obtained through data processing of computer.

The workflow of this invention is as follows: (1) When the coal level in bunker 23 is in a safe range, the FBG sensor 8 will transmit the stress signal to the static FBG Network Demodulator 13, and the optical signal will be converted into electrical signal by Demodulator 13. The electrical signal will be transmitted to the data processing system 21 of computer, and after it is inputted in through the analog software, the specific coal level will be shown on the displayer 20. At this time, the audible and visual alarm 15, the emergency brake valve 16 and the vibration device will not be triggered. The relationship between the coal level in bunker and the wavelength drift of FBG sensor is shown as FIG. 5, which indicates that the coal level is 5 m from the top of the coal bunker.

(2) When the coal level in the coal bunker 23 exceeds the upper limit, the FBG sensor 8 will transmit the signal to data processing system 21 through the FBG Network Demodulator 13. At this time, the audible and visual alarm 15 and the emergency brake valve 16 will respond quickly. The audible and visual alarm 15 will send out sound signals and light signals to remind the personnel to open the coal unloading port 19 in time and evacuate the surrounding workers. The emergency brake valve 16 will quickly stop the conveyer belt 24. The coal unloading port 19 at the bottom of the coal bunker is open to unload coal. The data processed by computer is shown as FIG. 6, which indicates that the coal level has reached the upper limit.

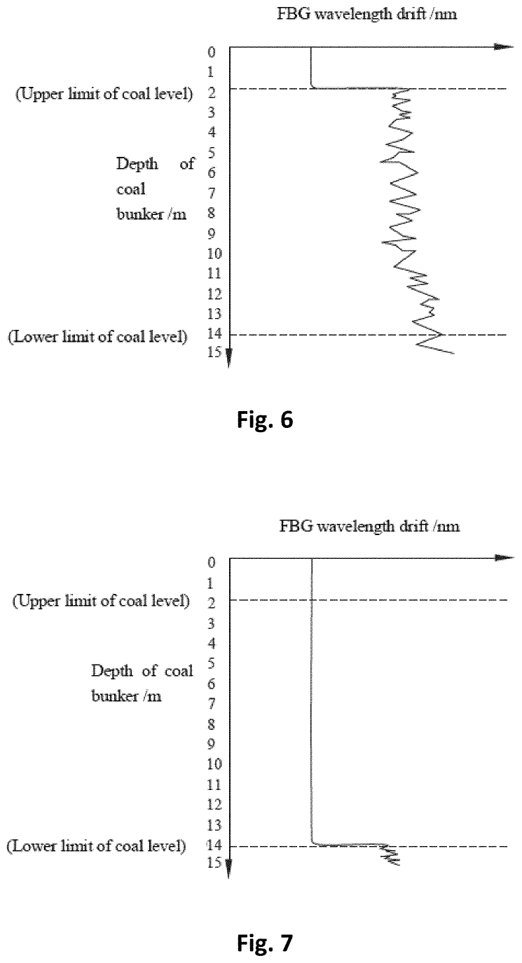

(3) When the coal level of the coal bunker is lower than the lower limit, the FBG sensor 8 will transmit the optical signal to the FBG Network Demodulator 13, which converts optical signal into electrical signal and transmit it to the data processing system 21. The displayer 20 will show the coal level and trigger the audible and visual alarm 15 to remind the workers underground to stop coal discharging at the coal unloading port 19 and prepare safety precaution. The data is shown as FIG. 7, which indicates that coal level has reached the lower limit, and safety measures should be taken immediately.

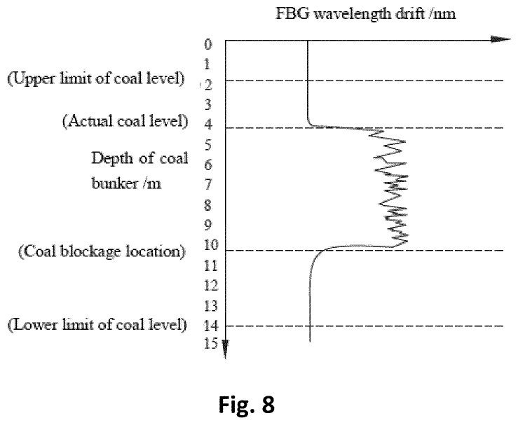

(4) When coal blockage occurs in the coal bunker 23, which means there is an empty area in the lower part of the coal bunker 23. FBG sensor 8 will sense the empty area and transmit the light signal to the FBG Network Demodulator 13. The light signal is converted into an electrical signal by the Demodulator 13 which is inputted to data processing system 21. The displayer 20 will show the exact height of coal blockage. The data processing system 21 will trigger the audible and visual alarm 15 and the emergency brake valve 16. Then the audible and visual alarm 15 will send out sound signals and light signals to remind the personnel to check the situation in time. The emergency brake valve 16 will stop the conveyer belt 24 in time to prevent the occurrence of accidents. After confirmation by the personnel, the vibration device will be manually turned on with the parameters of the adjustable-speed motor 3 being set, and then the vibration generator 6 starts to work, and the surrounding coal will fall due to the vibration. If this mean doesn't work, the parameters of the adjustable-speed motor 3 will be adjusted to make sure the coal falls. If the coal in the coal blockage area is so hard and bulky that the blockage can't be dredged by the vibration device, other solutions should be applied quickly. After the coal blockage is dredged and the coal level of coal bunker 23 is in a safe range, the vibration device, the audible and visual alarm device, and the emergency brake device will be released, and the belt conveyor 24 will continue to work. The data processed by the computer is shown as FIG. 8, which shows that the wavelength drift of FBG occurred at the height of 14 m from the top of the coal bunker, indicating that there is no stress on FBG below 14 m, i.e. coal blockage occurs here, and the above-mentioned measures should be taken immediately.

In the description of this invention, it is important to understand the orientation or positional relationship indicated by the terms “longitudinal”, “transverse”, “upper”, “lower”, “front”, “rear”, “left”, “right”, “vertical”, “horizontal”, “top”, “bottom”, “inner”, “outer”, etc. They are based on the orientation or positional relationship shown in the drawings and are only for the convenience of the description of this invention. They do not indicate or imply that the indicated device or element must have a specific orientation, or be constructed and operate in a specific orientation. It may mislead to a limited understanding of this invention.

The above-mentioned embodiments only describe the preferred mode of this invention and are not intended to limit the scope of the invention. Without departing from the design spirit of the invention, any other modifications and improvements made to the technical scheme of the invention by those common technicians in this field shall be included in the scope of protection determined by the claims of the invention.

1. A FBG intelligent device for monitoring coal level with test devices above the bunker (23) is characterized in that, it comprises of a supporting device above it and a vibration device extending into it, and the two devices are detachably connected. There is a surrounding reserved groove (7) for embedding FBG sensing device on the shell of the described vibration device. The described FBG sensing device is connected with the FBG Network Demodulator (13), and the described Demodulator (13) is electrically connected with the data processing system (21). The described data processing system (21) is electrically connected with an alarm device, and the described alarm device is connected with the conveyer belt (24).

2. According to claim 1, the described FBG intelligent device for monitoring coal level in bunker is characterized in that, the described supporting device comprises of supporting steel frames (1) symmetrically arranged at the left and right sides of the bunker, and the transverse supporting steel beam (2) is laid on the described supporting steel frames (1). The supporting steel beam (2) is transversely placed on the supporting steel frames (1) with the steel bar connectors (18).

3. According to claim 2, the FBG intelligent device for monitoring coal level in bunker is characterized in that, the described vibration device comprises of the adjustable-speed motor (3), the vibration connecting rod (5) and the vibration generator (6). The described vibration connecting rod (5) is connected with speed regulating motor (3) by a shaft; The described adjustable-speed motor (3) is detachably connected with the supporting steel beam (2), and the described vibration generator (6) is in threaded connection with the vibration connecting rod (5).

4. The FBG intelligent device for monitoring coal level of in bunker, according to claim 1, is characterized in that the FBG sensing device comprises of the FBG (8) which is wrapped by protective layer (9).

5. The FBG intelligent device for monitoring coal level in bunker, according to claim 4, is characterized in that the FBG sensing device comprises optical fiber (12) and FBG sensor (14). The described FBG (8) and FBG sensor (14) are connected in series in the optical fiber (12), which is connected with the FBG Network Demodulator (13).

6. The FBG intelligent method and device for monitoring coal level in bunker, according to claim 5, is characterized in that the tail-end of the optical fiber (12) is equipped with the fiber pigtail (11).

7. The described FBG intelligent monitoring method and device for coal level in bunker, according to claim 1, are characterized in that the alarm device comprises the audible and visual alarm (15) and the conveyor emergency brake valve (16). The described audible and visual alarm (15) is connected with the data processing system (21). One end of the conveyor emergency brake valve (16) is connected with the data processing system (21), and the other end is connected with the conveyer belt (24).

8. The FBG intelligent method and device for monitoring coal level in bunker, according to claim 7, are characterized in that, the audible and visual alarm (15) automatically send out sound alarm and flashlight beam when the coal level reaches the upper or lower limit to remind the personnel to check the coal bunker in time and eliminate the potential danger. The conveyor emergency brake valve (16) shall stop the conveyer belt (24) when the audible and visual alarm device is triggered.

9. The FBG intelligent method and device for monitoring coal level in bunker, according to claim 3, are characterized in that the described vibration device comprises the vibration buffer plate (4) which is arranged between the described supporting steel beam (2) and the adjustable-speed motor (3). The described vibration buffer plate (4) is in threaded connection with the supporting steel beam (2).

10. The FBG intelligent method for monitoring coal level in bunker is characterized in the following steps:
the FBG sensor (8) transmits the stress signal to the static FBG Network Demodulator (13) converting optical signal into electrical signal through the analysis processing and transmitting the electrical signal to the data processing system (21). After the electrical signal is inputted through simulation software, the specific coal level will be shown on the displayer (20) for the staff to supervise and take corresponding measures;
if the coal level in the bunker (23) exceeds or falls below the set limit, the audible and visual alarm (15), the emergency brake valve (16) and the vibration device will be triggered;
if coal blockage appears in the bunker (23), the displayer (20) will show the specific height of blockage; the data processing system (21) will trigger the audible and visual alarm (15) and the emergency brake valve (16). The audible and visual alarm (15) will send out sound and light signals to remind the personnel to check the situation in time, and the emergency brake valve (16) will stop the conveyer belt (24) in time.
